(19) United States
(12) Patent Application Publication
(10) Pub. No.: US 2023/0294151 A1
(43) Pub. Date: Sep. 21, 2023

(54) CATERPILLAR TRACK DRAWING METHOD AND CATERPILLAR TRACK DRAWING MACHINE

(71) Applicant: SMS group GmbH, Duesseldorf (DE)

(72) Inventor: Thomas CMIEL, Moenchengladbach (DE)

(73) Assignee: SMS group GmbH, Duesseldorf (DE)

(21) Appl. No.: 18/122,172

(22) Filed: Mar. 16, 2023

(30) Foreign Application Priority Data
Mar. 17, 2022 (DE) 10 2022 106 273.2

(51) Int. Cl. B21C 1/30; B21C 51/00

(52) U.S. Cl. CPC B21C 1/30; B21C 51/00

(57) ABSTRACT

A caterpillar track drawing method includes drawing a workpiece through a drawing die using a caterpillar track disposed behind the drawing die as seen in a drawing direction; and drawing a workpiece along a drawing line aligned parallel to the drawing direction while forming the workpiece by the drawing die. The caterpillar track includes circulating first and second drawing chains including chain links circulating parallel to a drawing plane. Each drawing chain is guided around first and second chain wheels having first and second axes aligned perpendicular to the drawing plane At least one measurable variable, inherent to the caterpillar track, of modules of the caterpillar track that resist or apply drawing force is recorded and optionally used for activation of a manipulated variable. In another aspect, a caterpillar track drawing machine includes the drawing die, the caterpillar track, and at least one measurable variable recorder.

### CROSS REFERENCE TO RELATED APPLICATIONS

Applicant claims priority under 35 U.S.C. § 119 of German Application No. 10 2022 106 273.2 filed Mar. 17, 2022, the disclosure of which is incorporated by reference.

### BACKGROUND OF THE INVENTION

### 1. Field of the Invention

The invention relates to a caterpillar track drawing method as well as to a caterpillar track drawing machine.

### 2. Description of the Related Art

As is common in the entire industrial sector, the quality of a manufactured workpiece is of special importance. Thus, even in the field of the drawing machine, different methods for guaranteeing the quality of the drawing stock to be drawn already exist. From EP 0 645 200 B1, for example, drawing machines are known that measure the drawing force exerted by the drawn bar on the drawing die in order to then set the drawing pressure in a manner depending correspondingly on the drawing force on the drawing die, so that it is possible to react to corresponding fluctuations of the drawing force on the drawing die. Drawing machines that use an automatic tensioning device for intermediate chains are also known, such as, for example, from EP 3 071 344 B1.

From WO 2020/229457 A1, for example, drawing systems are known in which quality features of the drawing stock, such as a drawn bar, for example, are used in controlled manner and for regulating intervention into the drawing process.

### SUMMARY OF THE INVENTION

It is an object of the present invention to master the result of the drawing process during a caterpillar drawing method or in a caterpillar track drawing machine as optimally as possible.

These and other objects are accomplished by a caterpillar track drawing method and a caterpillar track drawing machine having the features according to the invention. Further advantageous configurations, possible even independent of these features, are presented in or implicit from the following description.

In this regard, it is not absolutely necessary for a mastery of the result of a drawing process that the drawing stock was or will be drawn as optimally as possible. To the contrary, it is initially sufficient for this purpose if this result appears foreseeable as early as possible. On the other hand, it will be understood that an earliest possible prediction of the result of the drawing process then also makes it possible to act on the drawing process as purposefully and early as possible, in order to optimize this result.

In order to master the result of the drawing process during a caterpillar track drawing method or in a caterpillar track drawing machine as optimally as possible, a caterpillar track drawing method for drawing of a workpiece through a drawing die by means of a caterpillar track, which is disposed behind the drawing die as seen in a drawing direction and which draws a workpiece along a drawing line aligned parallel to the drawing direction while forming it by the drawing die and which comprises two circulating drawing chains, which comprise chain links and respectively circulate parallel to a drawing plane, wherein each of the drawing chains is guided around two chain wheels, the axes of which are aligned perpendicular to the drawing plane, can be characterized in that at least one measurable variable, inherent to the caterpillar track, of modules of the caterpillar track that resist or apply drawing force, is recorded.

It will be understood that especially two, three, four or more of such measurable variables, inherent to the caterpillar track, of modules of the caterpillar track that resist or apply drawing force may also be recorded. Especially given a suitable combination of such measurable variables, a mastery of the drawing result, i.e. of the result of the drawing process, can be accordingly further optimized.

Generic caterpillar track drawing methods traditionally operate with a caterpillar track that draws a workpiece through a drawing die.

In the present connection, the terms “workpiece” and “drawing stock” can be used synonymously. Both terminologies describe the workpiece that will be drawn by the caterpillar track and formed by means of the drawing die, i.e. also the object on which the caterpillar track drawing method is exerted.

By a “drawing die”, what can be understood in the present connection is a tool that has an opening through which material, which is usually metal, is drawn. In this way, the material that is drawn through the drawing die acquires the shape of the opening of the drawing die, taking possible spring-back effects into consideration, whereby a corresponding process of forming of the material and thus of the workpiece takes place. In the process, the material usually becomes simultaneously longer and thinner. Thus the use of a drawing die process is particularly well suited for drawing wires or tubes, for which the present caterpillar track drawing method is also particularly well suited. In this regard, the drawing die may also be referred to as a drawing ring, although it does not absolutely have to have a circular cross section.

Depending on concrete execution of the drawing method or drawing process, a drawing mandrel or plug may also be employed as an internal tool when tubes or hollow bars are being drawn.

In this regard, not only caterpillar track drawing methods but also further drawing methods exist, in which respectively a drawing stock is drawn through a drawing die and formed in the process. Thus, the drawing machine may comprise, for example, a drum track or even a two-sled track.

In this regard, a drawing machine, and therefore also an appropriate track, such as the drum track, the two-sled track or even the caterpillar track, applies a drawing force along a drawing direction, wherein the drawing die is then or will be disposed so that the drawing stock will be drawn through the drawing die along a drawing line aligned parallel to the drawing direction.

In this regard, the caterpillar track generally comprises two drawing chains, wherein a drawing chain preferably is composed respectively of several chain links connected with one another. Naturally, a workpiece must be gripped at least from two sides, in order to be able to draw this correspondingly with a certain force. Therefore two drawing chains situated opposite the workpiece are generally also used for the caterpillar track. In this regard, it will be understood that belts or drawing jaws disposed one after the other but not connected with one another may also be employed if necessary as drawing chains, and nevertheless a corresponding track is referred to as a caterpillar track.

Preferably, the chain links or other drawing tools driven by the circulating chains respectively apply drawing forces in the drawing direction or along the drawing line, because these chain links or other drawing tools interact frictionally or by force fit with the drawing stock over a drawing path. The corresponding direction of force on the drawing stock or workpiece is achieved by the chain links of the two drawing chains in the region of the drawing path, in a manner directed from oppositely disposed sides, wherein a drawing plane, in which the drawing line or drawing direction then lies or with which the drawing line or the drawing direction is aligned in parallel, may be defined by this direction of force.

The drawing forces can be applied in structurally particularly simple manner in that corresponding pressing forces are applied on the side of the chain links respectively facing away from the workpiece. This feature may be achieved, for example, by pressing beams or the like.

To reduce the friction, the pressing beams may carry rollers, on which the chain links travel past. For this reason, it is likewise possible to provide respectively an intermediate or idler roller chain or circulating rolling elements, which circulate between the respective pressing beams and the chain links and transmit the pressing forces. In general, however, such an intermediate chain does not transmit any kind of drawing forces, which preferably are applied via one or more chain wheels.

Each of the drawing chains is preferably guided around two chain wheels, which favors a structurally simple construction. At least one of the chain wheels or else the chain wheels may grip the drawing chain, for example between the chain links or on correspondingly constructed gripping pins or the like, so that a correspondingly sufficient interlocking between chain wheels and drawing chains is guaranteed, to ensure that the chain wheels are able to drive the drawing chain reliably. It will be understood that, in differing embodiments, a different driving interaction between one or more chain wheels may also be provided here.

A structurally particularly simple implementation may be realized when the axes of the chain wheels are aligned perpendicular to the drawing plane, i.e. when the chain wheels themselves are disposed parallel to the drawing plane. This arrangement permits in particular a configuration of the caterpillar track that is as compact as possible.

By “inherent to the caterpillar track” it may be preferably understood in the present connection that the measurable variable concerns the caterpillar track itself. The measurable variable inherent to the caterpillar track may therefore be measured on a module, which resists or applies a drawing force, of the caterpillar track itself. Thus, for example, the measurable variable inherent to the caterpillar track certainly does not describe any measurable variable recorded at the drawing die, because the drawing die is not part of the caterpillar track.

In the present connection, the measurable variables inherent to the caterpillar track are therefore recorded directly on modules of the caterpillar track and precisely not in regions outside the caterpillar track, such as at the drawing die, for example.

By the term “module that resists drawing force”, what may be understood in the present connection is preferably any module that resists the drawing force, which starts from the drawing die and via the drawing stock reaches the corresponding module. These modules include in particular the drawing chains, the chain wheels, the frame of the caterpillar track and possibly its drive.

By the term “module that applies drawing force”, what may then be understood in the present connection, for example, is any module that applies drawing forces. These modules include in particular the drive of the caterpillar track. Its frame, the chain wheels, and the drawing chains, however, may also be counted among the modules that apply drawing forces.

In general, an equilibrium of forces prevails in the caterpillar track, disregarding acceleration processes and short-term fluctuations. In this respect, even any module that resists drawing forces will in general also be a module that applies drawing forces and vice versa.

In this respect, it is provided at present that measurable variables inherent to the caterpillar track are measured at all modules of a caterpillar track that apply drawing forces or resist them. It has been found that the result of the drawing process can be better mastered by the inclusion of precisely these measurable variables. Given suitable configuration of the entire drawing process, corresponding measurable variables may be used correspondingly advantageously to pronounce statements about the result.

In this regard, it is initially immaterial in itself whether these statements are quantified as direct measured results or by means of supplementary calculations and then made available for an evaluation or whether, for example, only a qualitative evaluation such as “good” or “poor”, for example, is obtained from these statements.

During the process of drawing by the caterpillar track of a drawing machine, it may happen, for example, that the two drawing chains being used no longer run completely synchronously with one another. This situation may lead to an impairment of the quality of the drawn workpiece. By a suitable monitoring of measurable variables, inherent to the caterpillar track, of modules of the caterpillar track that resist or apply drawing force, it is possible, given suitable configuration in this respect, to perform a very timely quality check, i.e. following very shortly after the drawing process.

Cumulatively or alternatively, a caterpillar track drawing method for drawing of a workpiece through a drawing die by means of a caterpillar track, which is disposed behind the drawing die as seen in a drawing direction, which draws a workpiece along a drawing line aligned parallel to the drawing direction while forming it by the drawing die and which comprises two circulating drawing chains, which comprise chain links and respectively circulate parallel to a drawing plane, wherein each of the drawing chains is guided around two chain wheels, the axes of which are aligned perpendicular to the drawing plane, can be characterized in that at least one measurable variable, inherent to the caterpillar track, is recorded and used for activation of a manipulated variable of modules of the caterpillar track that resist or apply drawing force, in order to master the result of the drawing process during a caterpillar track drawing method or in a caterpillar track drawing machine as optimally as possible. Depending on concrete implementation, especially the drawing result, i.e. the result of the drawing process or the drawn drawing stock, which indeed represents the essential part of the drawing process, may also be optimized hereby, when the activation of the corresponding manipulated variable or manipulated variables follows the recorded measurable variable or variables in suitable manner.

It will be understood that especially two, three, four or more of such measurable variables, inherent to the caterpillar track, may also be recorded. Especially given a suitable combination of these measurable variables, a mastery of the drawing result, i.e. of the result of the drawing process, can be accordingly further optimized.

It will also be understood that especially two, three, four or more of such manipulated variables, especially when they are combined suitably with one another and possibly with the measurable variables in suitable manner, may be used in order to master or to optimize the result of the drawing process during a caterpillar track drawing method or in a caterpillar track drawing machine as optimally as possible.

By the “manipulated variables, inherent to the caterpillar track, of modules of the caterpillar track that resist or apply drawing force”, what can be understood in the present connection is all manipulated variables of modules that are able to resist or apply drawing forces and that can be positioned or changed in some form within the caterpillar track. Thus, corresponding manipulated variables may occur, for example, in the region of the drawing chain, of the drive or in the region of the frame. Because the drawing forces act on the workpiece via the caterpillar track into the frame on which the caterpillar track is disposed, the frame is also to be considered in this regard as a module of the caterpillar track that resists or applies drawing force.

In this way, it is possible with the present caterpillar track drawing method to provide, in a manner that depends on the recorded measurable variables inherent to the caterpillar track, a control and regulating system that controls or regulates the manipulated variables, inherent to the caterpillar track, of modules of the caterpillar track that resist or apply drawing force. For example, this control and regulating system may optimize the regulation of drawing chain speed in order to permit a synchronous or differentiated speed variation of both drawing chains. For example, diverse sensor systems may record the regulating values and thus optimize the movement of the drawing chains, whereby the quality of the drawing stock may also be improved. Likewise, given suitable configuration, the useful life of the system may be optimized by improved settings. It is conceivable that the regulation or control may also take place in fully or partly automated manner or even manually.

Due to the use, according to the invention, of the measurable variable, inherent to the caterpillar track, for activation of the manipulated variable, inherent to the caterpillar track, of modules of the caterpillar track that resist or apply drawing force, it is possible, for example, to achieve a constant torque variation of both drawing chains, so that no overload of one of the two drawing chains occurs. In addition, the useful life can be prolonged and the process of the caterpillar track drawing method can be improved. On the whole, all forces prevailing in the system can be optimally regulated.

Given suitable configuration of the caterpillar track drawing method, the quality of the drawing process can also be optimized by intervening in correspondingly regulating manner.

As already explained in the foregoing, it may happen, for example, during a process of drawing by the caterpillar track of a drawing machine, that the two drawing chains being used no longer run completely synchronously with one another. This situation may lead to an impairment of the quality of the drawn workpiece. Especially in this regard, a regulating or control intervention may improve the quality, for example. The synchronous running of the drawing chains can be set to a limited extent, for example via the pre-tensioning of the chains. It is additionally already common in the prior art to permit the synchronous running of the chains by means of mechanical synchronization of at least one gear mechanism or individual toothed gears. Here also it is then possible if necessary to intervene purposefully in controlling or regulating manner. Due to an asynchronous running of the drawing chains, the quality of the drawing stock may be correspondingly deteriorated, so that a synchronization is accordingly of advantage.

Preferably, the measurable variable can be a drawing chain measurable variable, because the drawing chain of the caterpillar track both resists and also applies drawing forces and in addition represents a measurable variable inherent to the caterpillar track. The drawing chain is directly in contact with the workpiece to be drawn, so that the drawing chain measurable variables are directly relevant for the quality of the drawing stock. In addition, the behavior of the drawing chains is jointly decisive for whether the two drawing chains continue to exhibit a synchronous running with one another.

One example of a drawing chain measurable variable is a drawing chain speed. By drawing chain speed, what is to be understood is the speed with which the drawing chain moves around the chain wheels or the speed with which an individual chain link advances the drawing chain. When the drawing chain speed of both drawing chains is measured, inferences may be made from this measurement as to whether the two drawing chains are running synchronously with one another, just as when, for example, the drawing chain speeds of the two drawing chains differ from one another. If the drawing chain speeds differ, the drawing chain speeds could be adapted correspondingly by a regulating and control system or by the caterpillar track method, so that the two drawing chain speeds of the two drawing chains are equal, whereby a synchronous running of the drawing chains can again be achieved. Because an asynchronous running of the drawing chains and thus a loss of quality of the drawing stock occurs due to different drawing chain speeds of the two drawing chains, it may be of particular importance to measure the drawing chain speed correspondingly.

Cumulatively or alternatively, the drawing chain measurable variable may be a drawing chain clamping pressure, by the measurement or monitoring of which a constant torque variation of both chains can be guaranteed and thus an overloading of one drawing chain may also be prevented. As already explained in the introduction, the drawing chain, which is guided around two chain wheels, is clamped by these chain wheels, as well as possibly by further clamping devices, with a certain pressure, which in the present connection may be referred to as drawing chain clamping pressure. Drawing chains that are not sufficiently clamped may prevent an operationally reliable process of drawing of the workpiece by the drawing chains. In particular, it is conceivable that, by a variation of the drawing chain clamping pressure, the effectively circulating length of the drawing chain can be varied, which then leads to different circulation speeds. In addition, the comparison of the drawing chain clamping pressures of both drawing chains may be of importance, because different drawing chain clamping pressures may cause the two drawing chains to no longer run synchronously with one another. By recording the drawing chain clamping pressure as a drawing chain measurable variable, in order to also use this drawing chain clamping pressure correspondingly if necessary for activation of a manipulated variable, inherent to the caterpillar track, of modules of the caterpillar track that resist or apply drawing force, the quality of the drawing stock can therefore also be improved, given suitable implementation. On the other hand, it is possible to make a statement about the quality of the drawing process or of the drawn drawing stock already from the recording of the drawing chain clamping pressure.

Naturally, vibrations that may be referred to as drawing chain vibrations in the present connection, occur during a caterpillar track drawing method in all modules of the caterpillar track drawing machine, as they also do in the drawing chain.

The drawing chain vibration can accordingly likewise be preferably a drawing chain measurable variable. This drawing chain vibration is influenced by a multiplicity of factors, such as, for example, the speed with which drawing takes place, the acting drawing forces, due to possible defects in the system or on the workpiece or even other influences. The drawing chain vibration, however, may lead to impairing the quality of the drawing stock if they are too large. In addition, a different drawing chain vibration between the two drawing chains can affect the synchronous running of the two drawing chains. In theory, a drawing chain vibration that is as similar as possible between the drawing chains appears in the first place to be particularly important for the synchronous running of the drawing chains. In the second place, a non-existent drawing chain vibration appears in theory to be optimal for the quality of the drawing stock. Because a vanishingly small drawing chain vibration appears unattainable in practice, however, the drawing chain vibration should be kept as small as possible. Due to the recording of the drawing chain measurable variable, the drawing chain vibration may be tested and used as a measure of the quality of the drawing process or of the drawn drawing stock as well as, if necessary, for activation of a manipulated variable, inherent to the caterpillar track, of modules of the caterpillar track that resist or apply drawing force, so that the drawing chain vibration may possibly be reduced or equalized between the drawing chains, in order in this way to improve the drawing stock quality or to ensure a synchronous running of the drawing chains.

Advantageously, the drawing chain measurable variable may also be a drawing chain temperature. Heat, which develops, for example, due to friction between individual elements, naturally is developed during a caterpillar track drawing method. Thus, for example, the drawing chain temperature in the present connection may also be understood as the temperature that prevails on the drawing chain or that the chain links of the drawing chain exhibit. Because the drawing chain applies or resists particularly high forces on the drawing stock to be drawn, the drawing chain temperature can vary and also increase proportionately during the caterpillar track drawing process. Because the temperature also influences the material properties, the material properties of the material of the drawing chain also change with varying drawing chain temperature. Thus, the interaction of the drawing chain with the workpiece is also changed. The properties of the drawing chain, such as, for example, its length, the inherent rigidity, its mobility and the like may also vary with the temperature, wherein such variations may also exert an influence on the drawing process and thus on the drawn workpiece or drawing stock. Thus, the quality of the drawing stock may likewise become poorer or vary due to a changing drawing chain temperature. In addition, the drawing chain temperatures of the two drawing chains may be different, so that the interaction of the individual drawing chains with the workpiece is different. This difference could result in an asynchronous running of the two drawing chains, so that the recording of the drawing chain temperature may be of particular importance as a drawing chain measurable variable both for the drawing stock quality and for a synchronous running of the drawing chains. The recorded drawing chain temperature could then be used, for example, for activation of a manipulated variable, inherent to the caterpillar track, of modules of the caterpillar track that resist or apply drawing forces, so that the drawing chain temperature drops, for example, or the two drawing chain temperatures of the two drawing chains are equalized.

It is of advantage when the drawing chain measurable variable is a drawing chain offset. By a “drawing chain offset”, what can be expressed in the present connection is an offset of the two drawing chains relative to one another. For example, a first chain link of the first drawing chain should in theory stand in drawing direction at equal height relative to a second chain link of the second drawing chain during the drawing process. In the ideal case, these two chain links selected by way of example and situated in drawing direction at a height, should also retain precisely this same height over the entire duration of the drawing process. In practice, however, it frequently occurs that the two chain links that at the beginning of the drawing process were still at one height in drawing direction are no longer at the same height, but instead a certain offset has developed between these two chain links. Such an offset may be understood correspondingly as a drawing chain offset.

Because the drawing chain is composed of several identical chain links, the offset of the chain links used in the foregoing by way of example for explanation also describes a drawing chain offset of the entire drawing chains relative to one another. Because a drawing chain offset between two drawing chains during a drawing process can reduce the quality of the drawing stock, however, the recording of the drawing chain offset as a chain measurable variable proves especially advantageous, because it is possible to react to it. Also, the drawing chain offset may be reasonably measured in operationally reliable and structurally simple manner. For example, the recorded drawing chain offset may likewise be used in order to make an early statement about the quality of the drawing process or of the drawn drawing stock or in order to activate a manipulated variable, inherent to the caterpillar track, of modules of the caterpillar track that resist or apply drawing forces and may be used in a control and regulating system for synchronization of the drawing chains.

Alternatively or cumulatively, it may be advantageous when the measurable variable is a drive train measurable variable. By the “drive train”, what can be understood in the present connection is any component that provides for a drive of the drawing chains. At first, the drawing chains are driven by the chain wheels. The chain wheels in themselves are driven by a corresponding gear mechanism or by a corresponding motor system, such as, for example, an electric motor or a hydraulic motor. Because some events in the drive train may therefore act directly or indirectly on the drawing chain and hereby the result of the drawing process may be influenced, it is also advantageous to record at least one drive train measurable variable. This variable or these variables can then be used in turn if necessary for activation of a manipulated variable, inherent to the caterpillar track, of modules of the caterpillar track that resist or apply drawing force, in order to permit precisely an automatic synchronization of the drawing chains of the caterpillar track and in addition also to optimize the quality and useful life of the drawing stock.

Preferably, the chain wheel torque may be recorded as a drive train measurable variable, because the chain wheel torque also directly influences the drawing force of the drawing chains with which these draw. Because the quality of the drawing stock can also be influenced by this drawing force in itself, precisely this measured value seems advantageous. Thus, different chain wheel torques could be determined, making it possible, for example, to observe that the drawing force of the drawing chains is certainly not synchronous or that the danger of slipping of the workpiece between the drawing chains exists. This measurable variable could then be used in turn if necessary for a control and regulating system, in order to use this variable for activation of the manipulated variable, inherent to the caterpillar track, of modules of the caterpillar track that resist or apply drawing force.

Cumulatively or alternatively, the drive train measurable variable may be a chain wheel rpm, because the chain wheel rpm influences the speed of the drawing chains and a different speed of the drawing chains and thus also a different chain wheel rpm can lead to difficulties between the drawing chains, especially when the chain wheels are driving the same drawing chain. Especially when the chain wheels drive the same drawing chain, a different chain wheel rpm may lead to undesired elongations and compressions of the respective drawing chain, which may possibly influence the drawing process. Different rpms of the chain wheels may also represent an indicator of different drawing chain speeds, which likewise may influence the drawing process. Correspondingly, the corresponding measured value may also be used if necessary for a controlling or regulating intervention via manipulated variables, inherent to the caterpillar track, of modules of the caterpillar track that resist or apply drawing force.

Advantageously, the drive train measurable variable may also be a chain wheel vibration, because the vibration of the chain wheels also has effects on the running of the drawing chains and thus also has influence on the quality of the drawing stock. Chain vibrations naturally develop due to the drive of the chain wheels, due to the drawing process or due to other influences. Too large vibrations of the chain wheels may result in losses of quality or changes of quality of the drawing stock. Due to the vibrations, the hold between drawing chain and workpiece could suffer and the drawing chain could slip through partially, for example, relative to the workpiece, whereby, on the one hand, the workpiece could be damaged and, on the other hand, could also cause an offset between the two drawing chains. Vibrations in themselves may also lead to feedback effects, by which oscillations are intensified and in this way the drawing process is detrimentally influenced. Because, in practice, a certain vibration cannot be prevented, but instead exists naturally, the chain wheel vibration should be of the same order of magnitude, at least for the chain wheels of both drawing chains, so that a synchronous running of the two drawing chains can be supported.

Preferably, the chain wheel temperature may also be recorded as a drive train measurable variable. In the present connection, the chain wheel temperature describes the temperature of a chain wheel or of the chain wheels. Heat may develop in the chain wheel, especially due to the friction of the chain wheels with the drawing chains, but also due to the circulation of the chain wheels and their internal flexing movement, whereby the chain wheel temperature can vary correspondingly during the drawing method.

The fluctuation of temperature of the chain wheels could also be responsible for a corresponding heat transfer to or from the drawing chains, which in turn are in contact with the drawing stock. Due to changing temperature, the material properties are changed, so that the chain wheel temperature causes changed material properties of the chain wheels and possibly also indirectly causes changed material properties of the drawing chains.

Due to the changed material properties, the mechanical interaction between the materials is also changed, just as, for example, between the chain wheel and the drawing chain or between the drawing chain and the workpiece. This change can have effects on the quality of the drawn drawing stock.

Furthermore, a different expansion of the chain wheels themselves could be caused by the changed chain wheel temperatures, so that the radius on which the drawing chains then turn around the respective chain wheel changes and the two drawing chains are influenced differently, so that running of the drawing chains may also be influenced.

The recording of the chain wheel temperature may be used accordingly not only for measurement of the result of the drawing process but instead also for activation of a manipulated variable, inherent to the caterpillar track, of modules of the caterpillar track that resist or apply drawing force, so that the chain wheel temperature can be part of a control and regulation system of the caterpillar track drawing method, in order to increase the quality of the drawing stock and, for example, to synchronize the drawing chains.

Likewise, it may be of advantage when the measurable variable is a frame measurable variable, because the forces developed or occurring during the drawing process are also transmitted to the frame of the caterpillar track drawing machine. From this frame measurable variable, it is also possible to derive conclusions about the actual drawing process, so that the quality of the drawing stock or the result of the drawing process can also be monitored with the recording of the frame measurable variables.

Vibrations are developed at the frame, especially due to the actual drawing process, to the drive of the drawing chains as well as to further possible influences, so that it is advantageous when a frame vibration is recorded as a frame measurable variable, so that conclusions about the result of the drawing process may possibly also be formed from this frame vibration. The frame vibration can be measured in various regions of the frame, because the frame vibration in certain regions are different from the frame vibrations in other regions. A conclusion about the drawing result may also be derived from this frame vibration if necessary. A too high frame vibration, possibly at certain frequencies, may also indicate on the whole that the drawing process is not proceeding optimally and thus is negatively impairing the quality of the drawing stock.

Cumulatively or alternatively, the frame measurable variable may be an oscillation that is present on the frame and is being measured correspondingly.

Oscillations may develop at the frame due to the actual drawing process, to the drive of the drawing chains as well as to further possible influences. It is naturally the case that oscillations develop at the frame during this method. These oscillations, however, should not exceed a certain range, because thereby the quality of the drawing stock may be influenced, because the drawing chains may possibly no longer be able to grip and draw the drawing stock properly and operationally reliably. Such an oscillation may also act up to the drawing die and directly influence the forming process taking place there. In addition, oscillations can have negative effects on the overall arrangement and possibly damage elements, for example when certain modules are oscillating at natural frequencies.

In the present connection, a distinction will be made between oscillations and vibrations. Oscillations can be more low-frequency and affect several modules, such as, for example, the drive train and the frame, whereas vibrations are generally high-frequency, often limited to only one module, such as, for example, to one drawing chain or to one chain wheel, and then influence other modules only partly. In general, oscillations are also characterized more by a substantial oscillation frequency, whereas vibrations generally involve an entire frequency spectrum. To this extent, oscillations influence the drawing process more directly and, in case of doubt, detrimentally, whereas vibrations, depending on concrete nature, may possibly be influenced by hardly measurable results, such as, for example a chain link that is becoming weaker. Hereby, conceivably detrimental events, such as, for example, a break of the corresponding chain link, may possibly be prevented. On the other hand, such vibrations may also correlate directly with properties of the drawn drawing stock, for example with its uniformity, and be used correspondingly for mastery of the drawing result.

Preferably, the frame measurable variable may also be a pressing pressure, which can influence the result of the drawing process.

By a “pressing pressure”, what can be understood in the present connection is preferably a pressure with which the drawing chains grip the drawing stock or which the two drawing chains exert on the drawing stock.

A certain pressing pressure is necessary so that the drawing stock or the workpiece can be drawn operationally reliably. A too high pressing pressure could damage the workpiece, whereas a too low pressing pressure may cause the workpiece to slip through between the drawing chains.

For this reason, it is practical to measure the pressing pressure, whereby this pressing pressure may be observed and possibly also regulated or controlled. This pressing pressure can be interpreted as a frame measurable variable, because on the one hand the frame must resist or apply the pressing pressure and on the other hand, however, the frame must also resist the drawing forces or apply them. In particular, the result of the measurement may be used on the one hand for timely determination of the quality of the drawing process. Likewise, however, this result may also be used to activate one or more manipulated variables, inherent to the caterpillar track, of modules of the caterpillar track that resist or apply drawing forces, or else to activate or to regulate the pressing pressure correspondingly.

In particular, the pressing pressure may be measured, for example, by correspondingly measuring or recording the pressure with which the drawing chain presses against the drawing stock or against one another or with which a pressing beam is pressed against the drawing chain.

It will be understood that the respective measurable variables can be mutually dependent on one another or can influence one another in some way. For this reason, it may be of advantage when as many drawing chain measurable variables as possible are recorded. For example, different drawing chain speeds, drawing chain clamping pressures, drawing chain vibrations and drawing chain temperatures between the two drawing chains may cause the actual drawing chain offset.

Advantageously, a material speed may be recorded additionally as an additional measurable variable, because the result of the drawing process during a caterpillar track drawing method or in a caterpillar drawing machine may be supplementarily mastered from the material speed.

By “material speed”, what can be understood in the present connection is preferably the speed with which the workpiece or drawing stock moves during the drawing process, wherein this speed is reliably determined decisively by the drawing chains. On the other hand, it is then possible to deduce a slipping or tensile stresses in the workpiece if comparisons, for example, are made here.

The material speed may therefore also be viewed in a relationship, for example with the drawing chain speed or the chain wheel rpm. In an optimal process of drawing of the workpiece by the drawing chains, the magnitude of the speed of the drawing chains is equal to the magnitude of the material speed. Should the two speeds differ from one another, slipping of the workpiece through the drawing chains could occur, because the drawing chain should actually always be in stable contact with the workpiece during drawing of the workpiece.

In addition, the material speed should be as constant as possible during the drawing process, because the workpiece should be drawn as uniformly as possible through the drawing die. During the occurrence of fluctuations of the material speed, for example toward lower values, this fluctuation may permit concluding that the workpiece has slipped through the drawing chains and in this case that the material speed has briefly decreased. In addition, the material speed may be related to a multiplicity of other measurable variable, because the material speed is influenced by many other measurable variables or jointly influences these directly. For this reason, the material speed can be readily integrated as a measurable variable, for example into a control and regulation process, which records and uses the measurable variables for activation of a manipulated variable, inherent to the caterpillar track, of modules of the caterpillar track that resist or apply drawing force.

Preferably, a drawing chain manipulated variable, i.e. a manipulated variable of a property of a drawing chain, is selected as a manipulated variable, because the drawing chain has direct influence on the drawing process and thus important parameters of the drawing chain can be manipulated directly.

Advantageously, the drawing chain manipulated variable is a drawing chain speed, because this drawing chain speed should match, especially in comparison with the drawing chain speed of the other chain, but also with the speed of the workpiece in the region of contact with the drawing chain. Should the speed of a workpiece be too fast, this workpiece speed may also be reduced by decreasing the drawing chain speed. In addition, differently high drawing chain speeds of the two drawing chains can cause an asynchronous running of the two drawing chains or can contribute to a slipping between drawing chains and a workpiece. Accordingly, this situation could be countered by manipulating the drawing chain speed at least of one of the two drawing chains in suitable manner.

Thus the drawing chain speed may also be used as a drawing chain manipulated variable as part of a control and regulating system, so that the speed of the drawing chains can be manipulated according to requirement or according to method sequences, in order in this way to ensure a synchronous running of the two drawing chains.

It is alternatively or supplementarily of advantage when the drawing chain manipulated variable is a drawing chain clamping pressure, because the clamping pressure of the drawing chain is likewise of great importance for a proper process of drawing of the workpiece by the drawing chains. Too loose or too lightly clamped drawing chains could cause, for example, a slipping between workpiece and drawing chains. Likewise, the drawing chain clamping pressure could, due to the correlated drawing chain tension, also have influence as regards the length of the chain and its circulation speed. The drawing chain clamping pressure between the two drawing chains should be equal for the running of the drawing chains to be as synchronous as possible. If the drawing chain clamping pressure is a drawing chain manipulated variable, the drawing chain clamping pressure may be manipulated in order, for example, to equalize or to decrease or increase the drawing chain clamping pressure of the two drawing chains. Thus, it is possible to react correspondingly to a non-synchronous running of the drawing chains or to a generally improper sequence of the drawing process.

Because the drive train of the drawing chains likewise has an influence on the drawing process, the manipulated variable may preferably also comprise or be a drive train manipulated variable, i.e. a manipulated variable, within the drive train, for the drawing chains, so that elements of the drive train may be manipulated correspondingly for the drive of the drawing chains, whereby the drawing process may be influenced.

Advantageously, the drive train manipulated variable may be a chain wheel torque, whereby especially the torque acting from the drawing chains on the workpiece to be drawn or the correspondingly acting forces may then also be influenced. The chain wheel torques of the two drawing chains should in themselves be as equal as possible, in order to permit a synchronous running of the two drawing chains. On the other hand, other factors, such as, for example, different circulation speeds or pressing pressures permit a differing positioning of the chain wheel torque to appear advantageous here in the individual case. For example, should one of the chain wheel torques be smaller than the other, the danger exists, on the other hand, that at least one of the drawing chains will slip over the workpiece to be drawn, whereby, on the one hand, the running of the drawing chains is no longer synchronous and also the workpiece quality suffers from it. Due to the possibility of being able to manipulate the chain wheel torque as a drive train manipulated variable, the chain wheel torque at least of one of the drawing chains can be correspondingly regulated or controlled and so a change of other parameters or measurable variables can also be taken into account.

It is also of advantage when the drive train manipulated variable is a chain wheel rpm. At first, the chain wheel rpm apparently correlates directly with the speed of drawing chains circulating around it or with the speed with which a workpiece to be drawn is drawn by the drawing chains. For a running of the two drawing chains to be as synchronous as possible, the chain wheel rpm of the two drawing chains in this respect should initially be equal. On the other hand, further factors, such as different chain tensions, different diameters of the chain wheels or else a play in the chains may also lead to deviations, so that an adapted positioning of the chain wheel rpm that takes further measurable variables into consideration may be advantageous.

Cumulatively or alternatively, gear mechanism settings may also be a drive train manipulated variable. The gear mechanism settings also influence the chain wheel torque or the chain wheel rpm directly or indirectly. The gear mechanism settings may therefore have effects on the running of the two drawing chains, such as, for example, with which speed or with which torque the drawing chains turn a workpiece. In order to influence the drawing process purposefully or in particular to optimize it in its result, the gear mechanism settings may then be manipulated. For example, these gear mechanism settings may be controlled or regulated, in order to keep the running of the two drawing chains synchronous or to keep other measured values in specified limits. By gear mechanism settings, what can be understood is especially all setting possibilities that can be set within a gear mechanism.

Especially the rpm of a motor drive or its drive torque may also be used as a drive train manipulated variable. This motor drive rpm or drive torque likewise permits a setting or regulating possibility, in order to optimize the drawing process in terms of its result.

It will be understood that a multiplicity of the actuators cited in the foregoing, such as, for example, the rpm of the drawing chains or of the chain wheels or the torque of the chain wheels and of the drive, correlate and may be or must be influenced in terms of their actual setting possibilities by means of identical modules, depending on concrete implementation. Thus, the chain wheel rpm, for example, may be initially correlated directly with the circulation speed of the associated drawing chain on the one hand and the drive speed of the associated drive. Deviations may occur here, however, due to varying circulation radii or due to fluctuations in the gear mechanism ratio, so that the associated regulating circuits are nested, possibly in complex manner, taking into consideration the planned measurable variables and actuators and, for example, in the choice of the chain wheel rpm as manipulated variable, of the gear mechanism setting and of the rpm of the drive are used for realization of this manipulated variable.

It is advantageous when the manipulated variable is a frame manipulated variable, because the frame must ultimately absorb the developed forces during the drawing process. Thus a frame manipulated variable may be, for example a pressing pressure. The pressing pressure may then be manipulated in a manner corresponding to the running of the two drawing chains or other measurable variables.

Preferably, a chain offset of the two drawing chains relative to one another may be determined from at least one of the measurable variables inherent to the caterpillar track, in order to be able to detect a non-synchronous running of the two drawing chains as directly as possible. For example, instead of making the direct measurement of the chain offset of the two drawing chains relative to one another via optical measuring means, it would be possible, for example, to compare the speeds of the two drawing chains with one another and from this comparison to determine whether a corresponding chain offset of the two drawing chains takes place at different speeds. The chain offset could also be determined, however, from any other measurable variables inherent to the caterpillar track. A direct measurement of the chain offset can take place, for example, by a comparison of the passages of individual chain links, by using the trailing or leading of the chain links directly as a measure for the chain offset. Such a chain offset may also be regarded in particular as a drawing chain measurable variable.

Cumulatively or alternatively, in order to improve the workpiece quality, a slipping between the workpiece and at least one of the two drawing chains may also be determined from at least one of the measurable variables inherent to the caterpillar track. For example, a different circulating speed of the two drawing chains may be an indicator for a slipping, because the different circulation speeds necessarily mean that one of the drawing chains or even both drawing chains are not running with the same speed as the drawn workpiece. Thus, for example, a slipping between the workpiece and at least one of the two drawing chains does not have to be detected via optical elements that compare the running of the drawing chains and of the workpiece with one another, but instead it may already be determined from at least one of the measurable variables inherent to the caterpillar track that a slipping between the workpiece and at least one of the two drawing chains is occurring. If the material speed of the workpiece exists, however, a direct test for a slipping may take place by the comparison with the drawing chain speed.

It will be understood that both a chain offset of the two drawing chains relative to one another and a slipping between the workpiece and at least one of the two drawing chains may be determined by differently combined measurable variables inherent to the caterpillar track. In particular, the corresponding variable may also be determined even more accurately, for example, by a combination of several measurable variables inherent to the caterpillar track. For this purpose, the measurable variables inherent to the caterpillar track may be combined in different ways. One of the measurable variables inherent to the caterpillar track, however, would already suffice if necessary in order to be able to determine a corresponding chain offset or a corresponding slipping. The determination of the corresponding values is especially possible, because both the measurable variables inherent to the caterpillar track and the chain offset of the two drawing chains relative to one another or a slipping between the workpiece and at least one of the two drawing chains are in a direct relationship to one another. All settings of the caterpillar track possibly have effects on the process of drawing of the workpiece and thus of a chain offset or slipping between the workpiece and at least one of the two drawing chains that possibly develop in the process.

Cumulatively or alternatively, in order to achieve the advantages mentioned in the foregoing, a wear of the drawing chains may also be determined from at least one of the measurable variables inherent to the caterpillar track. This wear can be detected, for example, by a slowing of the circulation speed, if the drawing chain becomes longer as a result of wear, or by an increase of the actuator travel for a drawing chain clamping device. An increased slipping may also be rated in this regard as an indicator. Likewise, it is conceivable to monitor vibrations, for example with respect to their frequency response, in order in this way to deduce a wear. The wear of the drawing chains may have effects on an operationally reliable process of drawing of the workpiece by the drawing chains. Because a wear of the drawing chains possibly can be achieved only with difficulty in a direct measurement, especially during the drawing process, the wear of the drawing chains may also be determined from at least one of the measurable variables inherent to the caterpillar track, as explained in the foregoing, so that a wear may be determined without direct measurement, for example by optical recording means, at any point in time from the measurable variables.

Preferably at least one regulating variable inherent to the caterpillar track will be regulated by manipulating at least one manipulated variable. In this way, it will be possible to use a control and regulating system that controls a drawing result that is as optimized as possible, in that the corresponding regulating variable is regulated by the manipulation at least of one manipulated variable. Thus a drawing result may then be controlled or optimized in automated manner.

By “regulating variable”, what can be understood in the present connection is, for example, a chain offset of both drawing chains relative to one another or a slipping between at least one of the two drawing chains and the workpiece or the chain tension of at least one of the two chains.

Therefore, it is advantageous when the chain offset of both drawing chains relative to one another or a slipping between at least one of the two drawing chains and the workpiece or the chain tension of at least one of the two chains can be regulated. The regulating variables mentioned in the foregoing are of great importance for a synchronous running of the two drawing chains and thus for the preservation of the workpiece quality during drawing. Depending on these variables, at least one of the manipulated variables may then be manipulated, whereby the regulating variables mentioned in the foregoing can be regulated.

When, for example, a chain offset of both drawing chains relative to one another occurs, at least one of the manipulated variables may be changed, so that the chain offset of both drawing chains relative to one another is minimized. In this case, a chain offset of zero could be the regulating variable, on which regulation is imposed correspondingly, because, for a proper running of the two drawing chains, no chain offset of both drawing chains relative to one another should be present if at all possible.

Correspondingly, it is also possible to react to a slipping between at least one of the two drawing chains and the workpiece and this regulating variable may be regulated by manipulating at least one manipulated variable. In general, a slipping between at least one of the two drawing chains should not even occur, so that any slipping could result correspondingly in a regulation of the at least one manipulated variable.

The chain tension of at least one of the two chains possibly does not have to have any generally fixed value, because this chain tension may be different depending on the method or depending on the workpiece being used. The chain tension may be defined in turn for the concrete method for a proper drawing process, however, so that the chain tension may be used correspondingly as a regulating variable and regulated by manipulating at least one manipulated variable, in order to optimize the workpiece quality.

In order to master the result of the drawing process during a caterpillar track drawing method or in a caterpillar track drawing machine as optimally as possible, a caterpillar track drawing machine, which comprises a drawing die and a caterpillar track disposed behind the drawing die as seen in a drawing direction and which is set up to draw a workpiece along a drawing line aligned parallel to the drawing direction while forming it by the drawing die and which comprises two circulating drawing chains, which comprise chain links and respectively circulate parallel to a drawing plane, wherein each of the drawing chains is guided around two chain wheels, the axes of which are aligned perpendicular to the drawing plane, can also be characterized in that the caterpillar track drawing machine comprises measurable variable recording means for recording at least one measurable variable, inherent to the caterpillar track, of modules of the caterpillar track that resist or apply drawing force.

By “measurable variable recording means”, what can be understood in the present connection are all means that are known to a person skilled in the art, especially from the field of measuring technology, in order to be able to measure certain physical variables. These means may be disposed or provided at correspondingly suitable places on the caterpillar track drawing machine.

Cumulatively or alternatively, a caterpillar track drawing machine, which comprises a drawing die and a caterpillar track disposed behind the drawing die as seen in a drawing direction and which is set up to draw a workpiece along a drawing line aligned parallel to the drawing direction while forming it by the drawing die and which comprises two circulating drawing chains, which comprise chain links and respectively circulate parallel to a drawing plane, wherein each of the drawing chains is guided around two chain wheels, the axes of which are aligned perpendicular to the drawing plane, can also be characterized in that the caterpillar track drawing machine comprises measurable variable recording means for recording at least one measurable variable inherent to the caterpillar track as well as at least one actuator, inherent to the caterpillar track, of modules of the caterpillar track that resist or apply drawing force and a control unit, which has a recording means input and an actuator output. The recording means input is connected with the measurable variable recording means in a relationship that transmits measurable variables and the actuator output is connected with the actuator, inherent to the caterpillar track, in activating relationship, in order to master the result of the drawing process during a caterpillar track drawing method or in a caterpillar track drawing machine as optimally as possible. In this regard, the result of the drawing process may be optimized, given suitable configuration by the activation of the actuators as a function of the measured values recorded by the measurable variable recording means.

It will be understood that especially two, three, four or more of such measurable variable recording means may also be provided, whereby, especially in a suitable combination of these measurable variable recording means, a mastery of the drawing result, i.e. of the result of the drawing process, can be accordingly further optimized.

It will also be further understood that especially two, three, four or more of such actuators, especially when they are combined suitably and possibly with the measurable variable recording means in suitable manner, can be used in order to master or to optimize the result of the drawing process during a caterpillar track drawing method or in a caterpillar track drawing machine as optimally as possible.

By “actuator”, what can be understood in the present connection is any element of the caterpillar track drawing machine that is adjustable or settable in some form. In particular, the actuator may be used to manipulate or to purposefully vary modules of the caterpillar track that resist or apply drawing force, which may also have, for example, direct effects on the running of the drawing chains, such as, for example, the speed of the drawing chains.

By “control unit”, what can be understood in the present connection is an electronic unit, which controls a certain process.

For this purpose, the control unit preferably has a recording means input, whereby measurable variables, which have been recorded by measurable variable recording means, can be transmitted to the control unit.

In addition, the control unit preferably comprises at least one actuator output, via which the control unit is connected in activating relationship with the actuator inherent to the caterpillar track.

It will be understood that the recording means input and/or the actuator output or the recording means inputs and/or the actuator outputs can be constructed in any form that is known in itself or conceivable and is suitable for implementing the task mentioned in the foregoing. In particular, suitable or respectively in-house measuring lines or control lines or even a bus system may also be provided here.

The control unit is therefore able to record and evaluate measurable variables via its recording means input. Depending on these measurable variables transmitted via the recording means input, the control unit is then able to activate the actuators inherent to the caterpillar track or the actuator inherent to the caterpillar track via the actuator output. Hereby especially a regulation can be provided, wherein the actuator is or the actuators are controlled by the control unit in a manner depending on the measurable variables. Thus, the control unit regulates or controls the drawing chains in such a way, for example, that they have a synchronous running and thus the quality and useful life of the drawing stock may be optimized.

In this regard, depending on concrete implementation, for example in the form of one or more traditional electrical or electronic activations, the control unit is able to form a regulating circuit. Likewise, it may be of advantage to supply the control unit cumulatively or alternatively by a data processing system, which implements corresponding activations by data processing simulation of such electrical or electronic activation. In particular, artificial intelligence, fuzzy logic or neural networks may also be used correspondingly in the control unit.

Preferably, the measurable variable recording means are drawing chain measurable variable recording means, which are capable of recording the most diverse measurable variables that relate to the drawing chain. Because the drawing chains represent an essential component of the caterpillar track drawing machine, and, for optimizing the quality and useful life of the drawing stock, especially the drawing chains are jointly responsible for contributing to the most optimal possible mastery of the result of the drawing process during a caterpillar track drawing method or in a caterpillar track drawing machine, it is advantageous when all measurable variables concerning the drawing chains can be recorded.

For example, it is of advantage when the drawing chain measurable variable recording means are drawing chain speed recording means, by which the speed of the drawing chains can be recorded. Especially when the drawing chains are to be automatically synchronized in order to have a correspondingly synchronous running, it is practical to record the speed of the drawing chains in order to compare them, especially with one another. Should drawing chain speeds of the two drawing chains differ from one another, it is to be assumed that the two drawing chains are not running synchronously with one another. Moreover, for certain method sequences or for certain workpieces, only a certain drawing chain speed can be specified in order to be able to guarantee a drawing process that is as operationally reliable as possible and in order to optimize the quality and useful life of the drawing stock.

Cumulatively or alternatively, the drawing chain measurable variable recording means may also be drawing chain clamping pressure recording means, which are capable of recording the drawing chain clamping pressure. The clamping pressure of the drawing chains represents an important variable of the drawing chain, which may influence the process of drawing of a workpiece by the drawing chains. In particular, the drawing chain clamping pressure of both drawing chains should also be equal for a running of the two drawing chains to be as synchronous as possible and in order to prevent a slipping between the workpiece and the respective drawing chain. In order to monitor this drawing chain clamping pressure correspondingly, it is practical when the drawing chain clamping pressure can be recorded on the drawing chains, so that it is also possible to counteract drawing chain clamping pressures that may be different.

Vibrations can occur naturally on the drawing chains of a caterpillar track drawing machine during the drawing process, and if these vibrations are correspondingly high they may also have negative effects on the quality of the drawing stock. In addition, the drawing chain vibrations may also contribute to an improper running of the drawing chains, whereby, for example, a slipping may occur between drawing chains and the workpiece or the drawing chains no longer run synchronously with one another. In order to be able to monitor these vibrations correspondingly, drawing chain vibration recording means prove to be particularly advantageous.

Cumulatively or alternatively, the drawing chain measurable variable recording means may preferably comprise drawing chain temperature recording means, which are able to measure the temperature of the drawing chains. Due to the process of drawing of the workpiece by the drawing chains, energy in the form of heat in the drawing chains and in the workpiece is developed at the drawing chains due to various physical sequences. Because the material properties of the drawing chain may also change with elevated temperatures, the behavior between drawing chain and workpiece may also change. The consequences could be, for example, a slipping between the workpiece and at least one of the drawing chains, a non-synchronous running of the drawing chains or a deterioration of the quality and useful life of the drawing stock. Differently large temperature elevations between the drawing chains also suggest an improper running of the drawing chains or an improper process of drawing of the workpiece by the drawing chains. For this reason, it is advantageous when the drawing chain temperature can be recorded and monitored by the drawing-chain temperature recording means.

It is also of advantage when the drawing chain measurable variable recording means are drawing chain offset recording means. Corresponding to the present diction, the drawing chain offset recording means are any measuring means that in particular are capable of recording an offset between the two drawing chains. During an optimal and synchronous running of the two drawing chains, precisely no offset exists between the two drawing chains even throughout the entire drawing process. Thus, the drawing chain offset recording means may also establish, with the recording of an offset between drawing chains, whether the two drawing chains are no longer running synchronously with one another or whether, for any reasons whatsoever, the undesired offset between the drawing chains has developed. Any undesired causes for the drawing chain offset should be advantageously eliminated, in order to optimize the quality and useful life of the drawing stock. Therefore, it is particularly practical to record or to monitor a possible offset of the two drawing chains relative to one another by the drawing chain offset recording means, in order then to be able to intervene correspondingly if necessary.

In order to master the result of the drawing process during a caterpillar track drawing method or in a caterpillar track drawing machine as optimally as possible, it may be particularly advantageous when the measurable variable recording means comprise drive train measurable variable recording means. The drive train forms an essential component of a caterpillar track drawing machine, because it is only by the drive train that the drawing chains of the caterpillar track drawing machine can be driven at all, in order in this way to draw the drawing stock or the workpiece. Thus, all components of the drive train also have effects on the drawing chains and thus on the process of drawing of the workpiece by the drawing chains. Therefore, it is also practical to record drive train measurable variables by the drive train measurable variable recording means, in order to master the result of the drawing process during a caterpillar track drawing method or in a caterpillar track drawing machine as optimally as possible or even to intervene in controlling or regulating manner if necessary.

Preferably, the drive train measurable variable recording means comprise chain wheel torque recording means. The chain wheel torque also acts directly on the forces that the drawing chain can exert on the workpiece during the drawing process, because the chain wheel drives the drawing chain. Should chain wheel torques of the chain wheels of one drawing chain be different or fluctuate differently from one another, for example, this situation may be an indicator of errors or discrepancies in the drawing chain circulation. On the other hand, should, for example, one chain wheel torque be different from a chain wheel torque of the other drawing chain, an improper running of the two drawing chains could be caused by this disequilibrium. This disequilibrium could result, for example, in a slipping of the workpiece with at least one of the two drawing chains and thus also in a non-synchronous running of the drawing chains. Thus the quality of the drawing stock may also be affected directly by different chain wheel torques. For this reason, it is of advantage when the chain wheel torques can be recorded or monitored by chain wheel torque recording means. It will be understood that the chain wheel torques of the two drawing chains do not absolutely have to be equal for an optimal drawing process, because, for example, a particularly large and heavy workpiece could require, due to its weight, higher torques for the chain wheel torque of the drawing chain disposed under the workpiece. But even different chain wheel torques, which should nevertheless be kept at a certain level, can be monitored particularly advantageously by the chain wheel torque recording means.

Cumulatively or alternatively, the drive train measurable variable recording means may also comprise chain wheel rpm recording means, which are able to record or measure the rpm of the chain wheels. Because the chain wheels drive the drawing chains, the chain wheel rpm is in a relationship with the drawing chain speed. Because the drawing chain speeds might not be negligible for the drawing result, as already explained in the foregoing, it is also particularly advantageous when the chain wheel rpm can be recorded and monitored by chain wheel rpm recording means.

Cumulatively or alternatively, the drive train measurable variable recording means may also be chain wheel vibration recording means, which at the chain wheels measure vibrations that can develop naturally during the drawing process. In case of doubt, these vibrations also have influence on the drawing process and, for example, may have negative effects on the quality and the useful life of the drawing stock. Therefore, it is also advantageous for the optimization of the drawing result when the vibrations at the chain wheel are measured by the chain wheel vibration recording means.

In order to achieve these same advantages, the drive train measurable variable recording means may comprise, cumulatively or alternatively, chain wheel temperature recording means. As already explained in the foregoing, elevated temperatures have effects on the material properties, so that too high temperatures of the chain wheel, wherein a change of the temperatures naturally occurs during the drawing process, could have negative effects on a proper running of the drawing chains or on an operationally reliable drive of the drawing chains.

Because the drawing chains should have a running that is as synchronous as possible or should be automatically synchronized, the components that drive the drawing chains in themselves are also of particular importance. These components that drive the drawing chains are components of the drive train, and when components of the drive train possibly do not function as intended, the synchronization of the drawing chains also can take place only with difficulty. For this reason, it is of advantage when the drive train measurable variable recording means are able, for example, to measure or monitor the chain wheel torque, the chain wheel rpm, the chain wheel vibration or the chain wheel temperature with the recording means mentioned in the foregoing.

In addition, the measurable variable recording means may also be frame measurable recording means, because the frame is also part of a caterpillar track drawing machine and thus, for example, forces that develop during the drawing process also act on the frame or are absorbed by the frame.

Vibrations also develop naturally at the frame during the drawing process, but preferably they should not be too large, because too large vibrations at the frame could cause an improper drawing process. Therefore, frame vibration recording means that are able to record or monitor the said vibrations at the frame prove particularly advantageous as frame measurable variable recording means. Thus, differently large vibrations at different regions of the frame could also be recorded, whereby a disequilibrium of the forces acting on the frame may be deduced. This force disequilibrium could be caused, for example, by a non-synchronous running of the two drawing chains or else by developing defects, so that a non-synchronous running of the drawing chains may be determined hereby.

Cumulatively or alternatively, the frame measurable variable recording means may also be oscillation recording means, because oscillations also develop naturally at a corresponding frame of a caterpillar track drawing machine. These oscillations, however, should lie in an order of magnitude that has no negative effects on the process of drawing the workpiece by the drawing chains, so that the quality of the drawing stock may be optimized. Therefore, it may be advantageous to record or monitor the oscillations by means of the oscillation recording means.

The magnitude of the pressing pressure of the drawing chains on the workpiece also acts on the magnitude of the forces transmitted to the frame. In order to be able to record and monitor these values, pressing pressure recording means may be used as frame measurable variable recording means. The pressing pressure may be highly informative in particular in order to record a synchronous running of the two drawing chains with one another, because differently high pressing pressures may lead to an improper or asynchronous running of the two drawing chains relative to one another.

Advantageously, the caterpillar track drawing machine comprises material speed recording means. The speed of the workpiece or of the drawing stock may be recorded by material speed recording means. As already explained in the foregoing, the speed of the material is of importance, because possibly certain material speeds that permit an operationally reliable drawing process are specified for the drawing process. For example, when this certain speed is to be maintained, it is practical to record or to monitor it via a material speed recording means. The material speed may also yield feedback, however, as to whether the drawing stock has been recorded continuously slip-free by the two drawing chains, or whether, for example, a slipping has occurred between the drawing stock and one of the two drawing chains. In an optimal drawing process, the material speed should be equal to the drawing chain speed, because then the drawing chain remains continuously at the same position of the workpiece and precisely no slipping has occurred.

It is of advantage when the actuator is a drawing chain manipulated variable actuator, with which variables of the drawing chain may be changed.

For example, the drawing chain manipulated variable actuator may be a drawing chain speed actuator, by which the speed of the drawing chains may be manipulated, such as, for example, increased or decreased. Thus the drawing chain speed may be adapted as needed, which is advantageous in particular when the drawing chain speeds are to be equalized with one another or are to be increased or decreased.

Cumulatively or alternatively, the drawing chain manipulated variable actuator may also be a drawing chain clamping pressure actuator, whereby the clamping pressure of the drawing chain may be set. For example, if the drawing chain has a too high or too low clamping pressure and thereby the drawing stock quality is possibly impaired, this drawing chain clamping pressure may be adapted by the drawing chain clamping pressure actuator. Corresponding advantages have also been explained already in the foregoing with reference to a corresponding manipulation process.

Because the drawing chains are driven in general via a corresponding drive train and this situation may therefore be of importance for a synchronous running of the drawing chains or for a mastery of the drawing result and additionally of importance for an optimization of the drawing stock quality, it is advantageous when the actuator is a drive train manipulated variable actuator.

Thus, the drive train manipulated variable actuator may be a gear mechanism setting actuator. By definition, gear mechanism settings can be manipulated by a gear mechanism setting actuator and may thus also influence the drive of the drawing chains. This feature is particularly advantageous when the drive of the drawing chains is to be adapted.

Cumulatively or alternatively, the drive train manipulated variable actuator may be a chain wheel torque actuator, whereby the torque of the chain wheel may be manipulated. The chain wheel torque may have effects directly or indirectly on the torque or on the force of the drawing chains and thus also on the running of the drawing chains. In order to be able to adapt the chain wheel torque correspondingly, a chain wheel torque actuator may be preferably provided accordingly.

A drive train manipulated variable actuator may also be a chain wheel rpm actuator. A chain wheel rpm actuator is able to set the chain wheel rpm, which in general also directly changes the drawing chain speed. Thus, if the speed of the drawing chains is to be adapted in some form, this adaptation may take place by the chain wheel rpm actuator. For example, a synchronization of the two drawing chains with one another could be achieved in that the chain wheel rpm of the two drawing chains is the same, so that, in case of different chain wheel rpm, these chain wheel rpm may be adapted correspondingly by at least one chain wheel rpm actuator.

Preferably, the actuator is a frame manipulated variable actuator, because the frame is also a component of the caterpillar track drawing machine that applies or resists drawing forces. Thus, the actuator may also be advantageously a pressing pressure actuator, because the frame exerts the pressing pressure of the two drawing chains on the workpiece and this pressing pressure can be set by the pressing pressure actuator. A too high pressing pressure could have negative effects on the quality of the drawing stock. In contrast, a too low pressing pressure could cause a lack of adhesion between drawing chain and workpiece, so that a slipping between the workpiece and at least one of the two drawing chains could be the consequence. In order to use the optimal pressing pressure, this pressing pressure may be set correspondingly by the pressing pressure actuator. It will be understood that further frame manipulated variable actuators, such as, for example, manipulable oscillation dampers or actuators for displacement of the frame or individual modules, may also be used accordingly advantageously if necessary.

Preferably, the caterpillar track drawing machine may comprise chain offset determining means using measurable variables inherent to the caterpillar track. The chain offset determining means determine an offset of the two drawing chains relative to one another. In general, however, this chain offset cannot be determined directly but instead can be measured via measurable variables inherent to the caterpillar track, such as, for example, the drawing chain speeds, and then determined by mathematical relationships. For example, different drawing chain speeds make it possible to deduce that a chain offset exists, so that, in this example, the chain offset determining means determine a chain offset from the drawing chain speeds. A direct determination by the comparison of instants of passage of individual chain links of the two drawing chains would be conceivable. The chain offset determining means are also able to determine the chain offset from any other combinations or single measurable variables inherent to the caterpillar track, however, because in certain cases the measurable variables inherent to the caterpillar track are in relationship with one another in certain ways.

In order to determine the wear of the drawing chains, wear determining means that use measurable variables inherent to the caterpillar track may be provided, wherein the wear in general is measured or determined not directly, for example by optical means on the drawing chains, but instead via the measurable variables inherent to the caterpillar track. For this purpose, different measurable variables inherent to the caterpillar track or different combinations of measurable variables inherent to the caterpillar track may be used, as already explained in the foregoing. For example, a slipping between workpiece and at least one of the two drawing chains could also suggest that the drawing chains are correspondingly worn and adequate adhesion between workpiece and drawing chain is no longer ensured. Stronger oscillations or vibrations could also be a consequence of a greater wear.

Cumulatively or alternatively, the caterpillar track drawing machine may comprise slipping determining means using measurable variables inherent to the caterpillar track. For example, the slipping determining means could compare the material speed with the drawing chain speed, which differ as soon as a slipping exists between the workpiece and drawing chains. Thus the slipping determining means determines a corresponding slipping between workpiece and at least one of the drawing chains and specifically does not measure directly. For the determination, the slipping determining means may rely on different measurable variables or different combinations of measurable variables.

Advantageously, the control unit comprises a chain offset control unit, wherein the chain offset control unit is able to control the chain offset, so that, upon occurrence of a chain offset, this offset can be immediately resisted in controlled manner, so that the drawing chains again run synchronously with one another and a chain offset is no longer present. Thus an automatic synchronization of the drawing chains can be achieved by the chain offset control unit.

Cumulatively or alternatively, the control unit may comprise a slipping control unit, which controls the drawing process in such a way that, as soon as a slipping occurs between the workpiece and at least one of the two drawing chains, this slipping can be correspondingly resisted, so that no further slipping still occurs. Thus an optimized drawing process can be automatically controlled that also optimizes the drawing stock quality.

Cumulatively or alternatively, the control unit may comprise a chain tension control unit, which controls the chain tension correspondingly, as soon as the chain is not tensioned in a manner corresponding to the required chain tension.

It will be understood that the chain offset control unit, the slipping control unit or the chain tension control unit ultimately may activate or comprise different actuators, such as, for example, actuators for adjustment of the drawing chain speed or the drive speed, actuators for variation of the pressing pressure and/or actuators for variation of the torques of the individual chain wheels or for variation of the pressing pressure.

The control units mentioned in the foregoing preferably have in common that they are able automatically to control the corresponding variables and for this purpose adjust corresponding actuators as a function of measurable variables. In this way, a corresponding control or regulation system may be provided for an optimal drawing process.

In order to configure the control unit optimally and in timely manner for the process, the control unit may comprise a neural network, a fuzzy logic, and artificial intelligence (AI) or a conventional control program for a programmable computing machine. In this way, the control unit may be optimized for its use, in order in this way to be able to react to as many occurring cases as possible with respect to the measurable variables and to understand them. Depending on type of control unit, the quality and the useful life of the drawing stock may therefore be optimized even further. In particular, it is possible in this way to assemble a multiplicity of measurable variables and actuators as a very complex regulating circuit, especially when, as already suggested in the foregoing, some of the measurable variables and actuators are in relationships with one another that are complex and possibly have not yet been researched in detail.

The caterpillar track drawing machine may advantageously comprise a regulating method for regulating the caterpillar track drawing machine. In this method, a drawing chain offset between the drawing chains may be regulated by the manipulation of the at least one actuator or actuators as a function of the one or more measurable variables, inherent to the caterpillar track, recorded by the measurable variable recording means. In this way, an automatic synchronization of the two drawing chains with one another may be achieved.

Cumulatively or alternatively, it is possible, by the manipulation of the at least one actuator or of the actuators as a function of the one or more measurable variables, inherent to the caterpillar track, recorded by the measurable variable recording means, to regulate a slipping between the workpiece and at least one drawing chain, in order to optimize the quality and useful life of the drawing stock.

For completeness, it is pointed out that, in the present connection, the respective measurable variables or manipulated variables do not absolutely have to be measured and processes in quantified manner or activated in quantified manner in their actual units. To the contrary, it is sufficient when values proportional to the measurable or manipulated variables are measured, processed or used for activation to a sufficient extent.

It will be understood that the features of the solutions described in the foregoing or in the claims may also be combined if necessary in order to be able to implement the advantages correspondingly cumulatively.

### BRIEF DESCRIPTION OF THE DRAWINGS

Further advantages, objectives and properties of the present invention will be explained on the basis of the following description of exemplary embodiments, which are also illustrated in particular in the accompanying drawing.

In the drawings,

FIG. 1 shows a caterpillar track drawing machine in a side view;

FIG. 2 shows the caterpillar track drawing machine according to FIG. 1 in perspective view; and

FIG. 3 shows a schematic view of a regulating method for the caterpillar track drawing machine according to FIGS. 1 and 2.

### DETAILED DESCRIPTION OF PREFERRED EMBODIMENTS

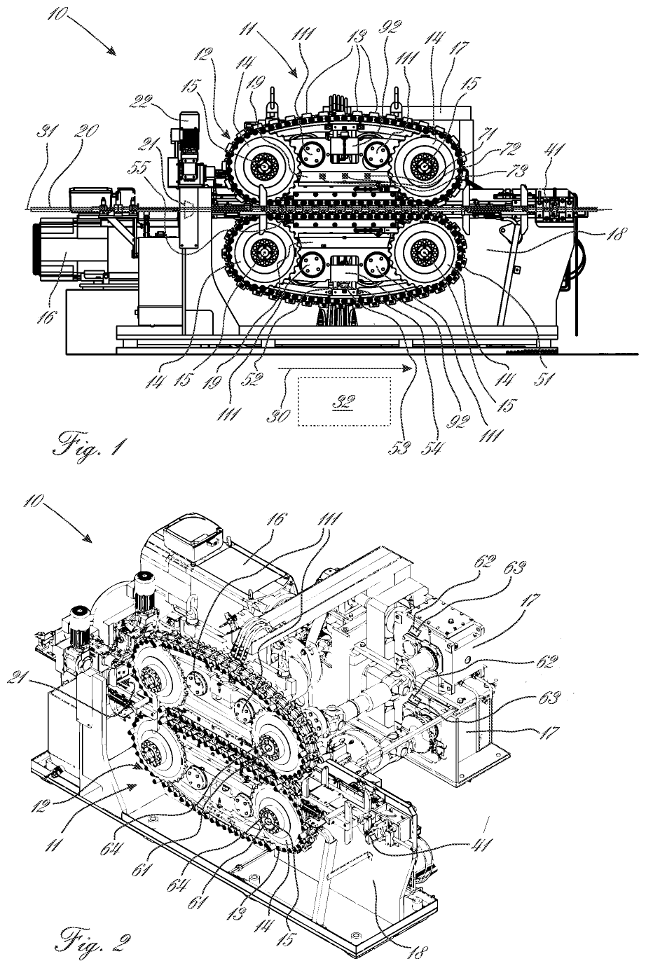

A caterpillar track drawing machine 10 comprises, as illustrated by way of example in FIGS. 1 to 3, a drawing die 21 and a caterpillar track 11, which is disposed behind the drawing die 21 as seen in a drawing direction 30 and which comprises two drawing chains 12, which respectively circulate parallel to a drawing plane 32, which in FIG. 1 represents the plane of the diagram, and which respectively comprise several chain links 13. In addition, each of the two drawing chains 12 is guided around two chain wheels 14, which respectively have axes 15, which are oriented perpendicular to the drawing plane 32.

The caterpillar track 11 is set up to draw a workpiece 20 along a drawing line 31 oriented parallel to the drawing direction 30 while forming it by the drawing die 21. In addition, the drawing die 21 comprises a motor adjustment 22, which is able to adjust the drawing die 21 correspondingly, wherein the formability of the drawing material as well as the temperature prior to the drawing process can also be measured at the drawing die.

The main drive of the caterpillar track drawing machine 10 or of the caterpillar track 11 takes place via drive 16, which in this exemplary embodiment is of electric motor construction. In differing embodiments, other drive types, for example hydraulic, are conceivable here. This drive is part of a drive train, in order to drive the caterpillar track 11.

The drive train additionally comprises, between the drive 16 and the chain wheels 14, two gear mechanisms 17, so that all drive forces from the drive 16 are distributed to two gear mechanisms 17. A first gear mechanism 17 is operationally connected with the chain wheel 14 of a first drawing chain 12, while the second gear mechanism 17 is connected with the chain wheels 14 of the second drawing chain 12, so that each gear mechanism 17 ensures the drive of the chain wheels 14 of respectively one drawing chain 12. The driven chain wheels 14 are likewise part of the drive train, just as is ultimately the respective drawing chain 12, which for its part then drives the workpiece 20 together with the other drawing chain 12.

Because the drawing chains 12 respectively run around two chain wheels 14, the gear mechanisms 17 respectively also drive one of the two drawing chains 12, so that, in the drive train of the caterpillar track 11, the drive 16 drives both drawing chains 12 via the gear mechanisms 17 and via the chain wheels 14.

During the drawing process, each of the drawing chains 12 then grips the workpiece 20 with a certain pressing pressure due to its chain links 13 and thereby draws the workpiece 20 along the drawing line 31 in drawing direction 30, wherein the workpiece 20 is formed by the drawing die 21.

In this exemplary embodiment, the chain links 13 respectively carry, in a manner known in itself, drawing tools, which bear on the workpiece 20 in a drawing area (not numbered), so that a drawing force can be transmitted from the drawing chains 12 to the workpiece 20 or to the drawing stock.

It will be understood that, in differing embodiments, it is possible to provide further drawing chains and other constructive differences, such as, for example, the exact mounting of the drawing chains 12, the concrete configuration of the gear mechanisms and the like. In particular, it is conceivable in a differing embodiment, that, for example, both chain wheels 14 of a drawing chain 12 are driven, in order to influence the running of the drawing chains 12, wherein it is then advantageous to match the torque distribution in the drive of these chain wheels 14 or their rpm suitably with one another.

During the drawing process, the drawing chains 12 move with a certain drawing chain speed, which is dependent on the drive 16, in a manner depending on how this drive drives the drawing chains 12. This drawing chain speed may be recorded or measured by drawing chain speed recording means 51. The drawing chain speed recording means 51 of the present exemplary embodiment are disposed directly in the surroundings of the chain links 13 of the drawing chain 12 that are traveling past. For example, the speed may be measured concretely by an inductive excitation of magnets that are traveling past and are mounted on the chain links 13. Likewise, for example, a photoelectric cell is able to record a passage of the chain links 13, in order then to deduce the speed from the clock cycle or the passage duration. It will be understood, however, that the drawing chain speed recording means 51 may also be disposed at another place in order to measure the drawing chain speed.

Because the drawing chains 12 are driven by the chain wheels 14 or the drawing chains 12 circulate around the chain wheels 14, the drawing chain speed is also dependent on the chain wheel rpm. The chain wheel rpm is also dependent on the drive by the gear mechanism 17 as well as by the transmission of force or rpm via the gear mechanisms 17. In the present exemplary embodiment, this chain wheel rpm can be recorded or measured via chain wheel rpm recording means 62, which are disposed on the gear mechanism 17. It is also conceivable, however, that the chain wheel rpm recording means 62 may be disposed at another place of the drive train, such as, for example, directly on the chain wheel 14, in order to measure the chain wheel rpm.

In addition, the drawing chains 12 are tensioned by the chain wheels 14 with a drawing chain clamping pressure. This drawing chain clamping pressure may be recorded or measured at the two drawing chains 12 by drawing chain clamping pressure recording means 52. These drawing chain clamping pressure recording means 52 are disposed in the region between the two chain wheels 14 of a drawing chain 12, respectively on an associated drawing chain clamping pressure actuator 92, by means of which the drawing chain clamping pressure can be manipulated, and they measure the drawing chain clamping pressure that the drawing chain 12 exerts on the drawing chain clamping pressure recoding means 52 or on the drawing chain clamping pressure actuator 92.

During the process of drawing of the workpiece 20 by the caterpillar track 11, vibrations that may be referred to as drawing chain vibrations naturally develop on the drawing chains 12. These vibrations may be recorded via drawing chain vibration recording means 53, which are disposed in a region that the drawing chain 12 passes through during circulation of the chain wheels 14.

The drawing chain temperature, which changes naturally during a drawing process, in particular rises, for example, may also be recorded or measured by drawing chain temperature recording means 54. These drawing chain temperature recording means 54 may be disposed directly in a region between the chain wheels 14 past which the drawing chain 12 travels. It will be understood, however, that the drawing chain temperature recording means 54 may also be disposed at any other place in the region of the caterpillar track 11, provided that the drawing chain temperature can also be measured at this place.

It is possible that the two drawing chains 12 have a drawing chain offset relative to one another, which is to be recognized in that, for example, individual chain links 13 of the drawing chains 12 no longer run parallel to one another but instead have an offset relative to one another. Such a drawing chain offset may then be detected, as in the present exemplary embodiment, by drawing chain offset recording means 55, which in the present version is disposed in the region of the workpiece 20 between the two drawing chains 12, because the synchronous running of the two drawing chains 12 or of the chain links 13 can be recorded particularly well here. Other measuring methods, however, are also conceivable in order to record a drawing chain offset between the two drawing chains 12. Thus, for example, respectively an inductive excitation of magnets that are traveling past and mounted on the chain links 13 or a passage of the chain links 13 recorded by a photoelectric cell may be used in order to deduce the offset from the deviation of the passages from one another or a change of the offset from a change of the deviation.

For a drive of the chain wheels 14, these chain wheels are naturally driven with a certain torque, which may be referred to as the chain wheel torque. Aside from natural oscillations of the chain wheels or aside from tensions and torsions of the chain wheels, etc., the chain wheel torque also describes the torque with which the chain wheels 14 drive the drawing chains 12. The chain wheel torque may be recorded or measured by chain wheel torque recording means 61. In the present exemplary embodiment, the torque measurement takes place, for example, via strain gauges, wherein the chain wheel torque recording means 61 are disposed on the chain wheel 14. It will be understood that the torque may also be recorded or measured in another region of the drive train, for example, such as, for example, in the gear mechanism 17 or between gear mechanism 17 and chain wheel 14 or via other torque sensors.

The vibrations present at the chain wheel 14 and developed during the drawing process may also be recorded as chain vibration via chain wheel vibration recording means 63, which in the present exemplary embodiment are disposed on the gear mechanism 17. The chain wheel vibration recording means 63 may also be disposed, however, directly on the chain wheel 14 or another part of the drive train. In particular, if the chain wheel torque recording means 61 are implemented as strain gauges, for example, they may also be used as chain wheel vibration recording means 63.

At the chain wheel 14 itself, temperature fluctuations, which develop naturally due to the physical processes, also develop during the drawing process, wherein this chain wheel temperature may be recorded or determined via chain wheel temperature recording means 64, which are disposed directly on the chain wheel 14. It is conceivable that the chain wheel temperature recording means 64 are also not disposed directly on the chain wheel 14 and, for example, are able to measure the chain wheel temperature contactlessly.

The vibrations developing during the drawing process are also transmitted to a frame 18 of the caterpillar track 11. These frame vibrations may be recorded or measured at some place on the frame via frame vibration recording means 71. In the present exemplary embodiment, the frame vibration recording means 71 is disposed in a region between the two chain wheels 14 on a pressing beam 19, known in itself, which via an intermediate chain, likewise known in itself and illustrated only schematically as well as unnumbered, exerts a pressing pressure in the direction of the workpiece 20, so that the drawing tools are able to grip the workpiece 20, wherein these load-bearing components may also be disposed if necessary at another suitable place of the caterpillar track 11.

This pressing beam 19 can be positioned via pressing pressure actuators 111 in or parallel to the drawing plane 32 with a component perpendicular to the drawing line 31 or drawing direction 30, which actuators, in this exemplary embodiment, are constructed as eccentric gears, known in themselves, with which a chain wheel carrier, comprising the pressing beam 19 and not separately numbered here, can be positioned in or parallel to the drawing plane 32 with a component perpendicular to the drawing line 31 or drawing direction 30.

In addition, oscillations, which in the present exemplary embodiment can be measured or recorded via oscillation recording means 72, develop naturally on the caterpillar track drawing machine 10.

During the process of drawing of the workpiece 20 by the drawing chains 12, the drawing chains 12 exert, on the workpiece 20, a certain pressing pressure, which, as already suggested in the foregoing, can be applied by the pressing beam 19 and is also of importance for an operationally reliable drawing process as well as for preserving the quality of the workpiece 20. This pressing pressure may be measured or recorded via pressing pressure recording means 73 on the caterpillar track 11.

The oscillation recording means 72 and the pressing pressure recording means 73 are also provided on the pressing beam 19 in this exemplary embodiment, wherein, in differing embodiments, they may also be provided at another suitable place.

In addition, the material speed of the workpiece 20 is measured by material speed recording means 41 in a region in drawing direction 30 behind the caterpillar track 11. It will be understood that the material speed may also be measured in other regions of the caterpillar track 11, such as, for example, in the region in which the workpiece 20 is in contact with the drawing chains 12 or, viewed in drawing direction 30, in front of the caterpillar track 11 or between the drawing die 21 and the caterpillar track 11.

In addition, the caterpillar track drawing machine 10 of the present exemplary embodiment has numerous possibilities for being able to adjust parameters that concern the process of drawing by the caterpillar track 11 or the caterpillar track 11 directly.

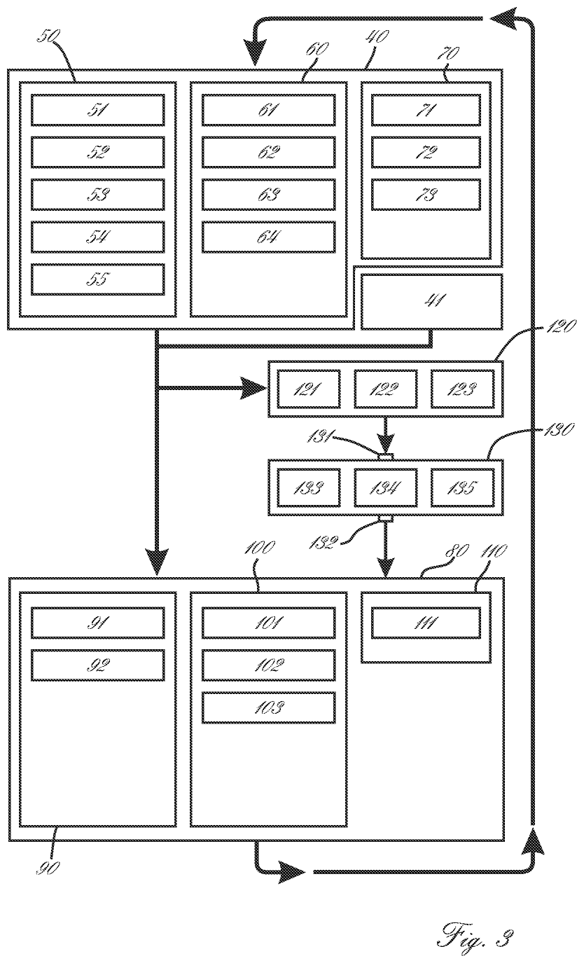

Thus, the caterpillar track 11 has drawing chain speed actuators 91, which are able to change the drawing chain speed. These drawing chain speed actuators 91 are in particular part of the drive 16 or of the gear mechanism 17 and as such are disposed within these units, so that the drawing chain speed actuators 91 are not further illustrated in the diagrams according to FIGS. 1 and 2 of the present exemplary embodiment. For example, however, devices are also conceivable by which the running radius of the drawing chains 12 around the chain wheels 14 may be modified, which, in the case of a driven chain wheel 14, then has a corresponding influence on the drawing chain speed, so that such a device is likewise to be rated as a drawing chain speed actuator 91.

Drawing chain clamping pressure actuators 92, which are able to push the drawing chains 12 perpendicular to the drawing direction 30 at the side of the drawing chains 12 facing away from the workpiece 20, in order to clamp the drawing chains 12 or to change the drawing chain clamping pressure, are disposed between the chain wheels 14, as already explained in the foregoing. In the present exemplary embodiment, the drawing chain clamping pressure recording means 52, the drawing chain vibration recording means 53 and the drawing chain temperature recording means 54 are also disposed on this drawing chain clamping pressure actuator 92.

Moreover, important parameters for the drive of the chain wheels 14 can also be changed via gear mechanism setting actuators 101, which are disposed within the gear mechanism 17. The gear mechanism setting actuators 101 are also disposed within these units, so that they are not further illustrated in the diagrams according to FIGS. 1 and 2 of the present exemplary embodiment.

The chain wheel torque or the chain wheel torques are also changed in the present exemplary embodiment via chain wheel torque actuators 102, so that, for example, the torque of the chain wheels 14 or their rpm may be changed as needed. Likewise, the chain wheel torque actuators 102 are disposed within the gear mechanism 17, so that they are likewise not further illustrated in the diagrams according to FIGS. 1 and 2 of the present exemplary embodiment.

The chain wheel rpm of the chain wheels 14 may also be changed in similar manner, in that chain wheel rpm actuators 103, which likewise are not separately visible in the diagrams of FIGS. 1 and 2, are disposed, however, in the region of the chain wheel 14 or of the gear mechanism 17 or in the region of the drive train.

In addition, the pressing pressure is set by the pressing pressure actuator 111 already explained in the foregoing, so that the pressure with which the drawing chains 12 press on the workpiece 20 can be changed.

The caterpillar track drawing machine 10 of the present exemplary embodiment comprises a regulating and control system, as is illustrated schematically in FIG. 3. The drawing chain speed recording means 51, the drawing chain clamping pressure recording means 52, the drawing chain vibration recording means 53, the drawing chain temperature recording means 54 and the drawing chain offset recording means 55 are assembled as the drawing chain measurable variable recording means 50 and thus represent all variables that concern the drawing chain 12 and correspondingly may be grouped as drawing chain measurable variable recording means 50.

In addition, the chain wheel torque recording means 61, the chain wheel rpm recording means 62, the chain wheel vibration recording means 63 and the chain wheel temperature recording means 64 may be assembled as the drive train measurable variable recording means 60, which respectively describe the measurable variables concerning the drive train.

The frame vibration recording means 71, the oscillation recording means 72 and the pressing pressure recording means 73 may be grouped under frame measurable variable recording means 70, because these recording means record measurable variables that are related to the frame 18.

It will be understood that, in addition to the recording means mentioned in the foregoing, further recording means may be included under the drawing chain measurable variable recording means 50, the drive train measurable variable recording means 60 and the frame measurable variable recording means 70, because it is conceivable that still further physical parameters, not mentioned, may be recorded on the caterpillar track 11 or on the caterpillar track drawing machine 10, for which corresponding recording means may then be expedient. The mentioned recording means 50, 60 and 70 as well as also the material speed recording means 41 can be grouped on the whole as measurable variable recording means 40 for recording measurable variables, inherent to the caterpillar track, of modules of the caterpillar track 11 that resist the drawing force or apply it.

Supplementarily, still further recording means may be provided, such as the material speed recording means 41 provided by way of example in this exemplary embodiment.

In addition, all actuators 80 may also be grouped correspondingly.

Thus, drawing chain speed actuators 91 and drawing chain clamping pressure actuators 92 are grouped together as drawing chain manipulated variable actuators 90.

The gear mechanism setting actuators 101, the chain wheel torque actuators 102 and the chain wheel rpm actuators 103 are referred to collectively as drive train manipulated variable actuators 100.

The pressing pressure actuator 111 may also be described in general as a frame manipulated variable actuator 110, wherein, in differing embodiments, further frame manipulated variable actuators 110 may be provided, as already explained in the introduction.

The actuators 80 therefore comprise all drawing chain manipulated variable actuators 90, drive train manipulated variable actuators 100 and frame manipulated variable actuators 110. In addition, it is conceivable that further actuators 80 may also be provided in order to be able to adjust any manipulated variables whatsoever that may be part of the caterpillar track 11.

By way of example, part of the regulating and control system in the present exemplary embodiment are also determining means 120, which comprise chain offset determining means 121, wear determining means 122 and slipping determining means 123. As indicated in FIG. 3, these determining means use measured data supplied by the measurable variable recording means 40 as well as the material speed recording means 41 and, in other embodiments, further or alternative recording means, in order to determine corresponding data by implementing suitable data links.

In addition, the entire process in this exemplary embodiment is controlled supplementarily via a control unit 130, which comprises a chain offset control unit 133, a slipping control unit 134 and a chain tension control unit 135.

The control unit 130 has, in this exemplary embodiment, a determining means input 131, by which parameters are transmitted from the determining means 120, as well as also an actuator output 132, in order to transmit corresponding settings or adjustments to the actuators 80.

Alternatively or cumulatively, it is also possible to provide, in the control unit 130, recording means input, by which measurable variables from the measurable variable recording means 40 or further recording means, such as the material speed recording means 41, may be fed correspondingly to the control unit 130, in order then to be able to transmit corresponding settings or adjustments to the actuators 80.

The regulating method for regulating the caterpillar track drawing machine 10 of the present exemplary embodiment regulates, as is illustrated in FIG. 3, the chain offset between the two drawing chains 12 via the chain offset control unit 133. In addition, the slipping control unit 134 regulates a slipping between the workpiece 20 and at least one of the two drawing chains 12. Furthermore, the chain tension control unit 135 regulates the chain tension of the two drawing chains 12.

For this purpose, the measurable variables, inherent to the caterpillar track, of modules of the caterpillar track that resist or apply drawing force, are recorded via the measurable variable recording means 40. From these measurable variables and possibly the material speed, which is recorded via the material speed recording means 41, a chain offset, a wear, and a slipping are then determined via the determining means 120. These variables may be determined from at least one of the measurable variables that are recorded by the measurable variable recording means 40, or by a combination of various measurable variables. This determination is possible because the measurable variables are in a direct relationship with the chain offset, with the wear or with a slipping between workpiece 20 and drawing chain 12. For example, a chain offset could be deduced from different drawing chain speeds between the two drawing chains 12. A high wear of the drawing chains 12 could be determined, for example, from increased vibrations. An unequal material speed of the workpiece 20 makes it possible, for example, to deduce an at least partial slipping between the workpiece 20 and at least one of the two drawing chains 12.

It will be understood that all other measurable variables or combinations of these measurable variables may also be used in order to determine a chain offset, a wear, or a slipping with the determining means 120.

Depending on the measurable variables, inherent to the caterpillar track, measured by the measurable variable recording means 40 and on the chain offset, wear, or slipping determined from them, the actuators 80 are then adjusted.

Because both a chain offset and also an increased wear as well as a slipping between workpiece 20 and the drawing chains 12 is undesired, the actuators 80 will adapt the manipulated variables correspondingly, in order to counteract these situations.

For example, if a chain offset occurs, the drawing chain speed of at least one of the two drawing chains 12 may be adjusted, so that the two drawing chains 12 again run synchronously with one another.

Also, for example, the pressing pressure could be adapted by the pressing pressure actuator 111, in order to counteract an increased wear.

It is possible to react, for example, to a slipping between the workpiece 20 and at least one of the two drawing chains 12 in that the drawing chain clamping pressure actuator 92 increases the drawing chain clamping pressure, in order to prevent a corresponding slipping.

It will be understood that various measures or positioning capabilities of the actuators 80 are possible in order to regulate the process correspondingly.

In this regard, especially a difference of the measurable variables or of the manipulated variables of the two drawing chains 12 relative to one another may also be of importance, because especially a disequilibrium between the two drawing chains 12 may cause a non-synchronous running of the two drawing chains 12.

Thus, depending on the measurable variables inherent to the caterpillar track and on the parameters determined from them by the determining means 120, the manipulated variables, inherent to the caterpillar track, of modules of the caterpillar track 11 that resist or apply drawing force, can be activated by the actuators 80, in order to achieve an automatic synchronization of the drawing chains 12 of the caterpillar track 11 of the caterpillar track drawing machine 10 as well as an optimization of the quality and useful life of the drawing stock.

In addition, the possibility exists in the regulating method of the present caterpillar track drawing machine 10, that the measurable variables, inherent to the caterpillar track, of modules of the caterpillar track 11 that resist or apply drawing force, recorded by the measurable variable recording means 40, or measurable variables recorded by further recording means, such as the material speed recording means 41, can be fed partly or completely to an artificial intelligence, to a neural network and/or to a fuzzy logic, in order to activate the actuators 80 correspondingly or else only in order to output suitable parameters as information about the quality of the drawing process, for example via a monitor, a warning system in the case of critical deviations, or a data memory or paper printout.

In this regard, the determining means 120 or even the control unit 130 may be implemented if necessary in the artificial intelligence, in the neural network or in the fuzzy logic and not in standalone manner. If necessary, however, corresponding parameters may furthermore be output for information purposes or for control purposes.

Depending on concrete configuration, it is also possible here to employ in particular mixed forms between conventional control and regulation technology, computer-assisted control and regulation technology as well as modern control and regulation methods, such as can be realized by artificial intelligence, neural networks or the fuzzy logic.

It appears essential that especially at least one measurable variable, inherent to the caterpillar track, of modules that resist or apply drawing force or corresponding measurable variable recording means be used as input variables or that the activation of manipulated variables, inherent to the caterpillar track, of modules that resist or apply drawing force take place from the recording at least of one measurable variable inherent to the caterpillar track or that the latter be used for activation of a manipulated variable, inherent to the caterpillar track, of modules of the caterpillar track 11 that resist or apply drawing force.

Although only a few embodiments of the present invention have been shown and described, it is to be understood that many changes and modifications may be made thereunto without departing from the spirit and scope of the invention.

### LIST OF REFERENCE SYMBOLS

10 Caterpillar track drawing machine
11 Caterpillar track
12 Drawing chain
13 Chain link
14 Chain wheel
15 Axis of the chain wheel 14
16 Drive
17 Gear mechanism
18 Frame
19 Pressing beam
20 Workpiece
21 Drawing die
22 Motor adjustment
30 Drawing direction
31 Drawing line
32 Drawing plane
40 Measurable variable recording means
41 Material speed recording means
50 Drawing chain measurable variable recording means
51 Drawing chain speed recording means
52 Drawing chain clamping pressure recording means
53 Drawing chain vibration recording means
54 Drawing chain temperature recording means
55 Drawing chain offset recording means
60 Drive train measurable variable recording means
61 Chain wheel torque recording means
62 Chain wheel rpm recording means
63 Chain wheel vibration recording means
64 Chain wheel temperature recording means
70 Frame measurable variable recording means
71 Frame vibration recording means
72 Oscillation recording means
73 Pressing pressure recording means
80 Actuator
90 Drawing chain manipulated variable actuator
91 Drawing chain speed actuator
92 Drawing chain clamping pressure actuator
100 Drive train manipulated variable actuator
101 Gear mechanism setting actuator
102 Chain wheel torque actuator
103 Chain wheel rpm actuator
110 Frame manipulated variable actuator
111 Pressing pressure actuator
120 Determining means
121 Chain offset determining means
122 Wear determining means
123 Slipping determining means
130 Control unit
131 Determining means input
132 Actuator output
133 Chain offset control unit
134 Slipping control unit
135 Chain tension control unit

What is claimed is:

1. A caterpillar track drawing method comprising:
drawing a workpiece through a drawing die using a caterpillar track disposed behind the drawing die as seen in a drawing direction; and
drawing a workpiece along a drawing line aligned parallel to the drawing direction while forming the workpiece by the drawing die;
wherein the caterpillar track comprises circulating first and second drawing chains comprising chain links circulating parallel to a drawing plane;
wherein each of the first and second drawing chains is guided around first and second chain wheels having first and second axes aligned perpendicular to the drawing plane;
wherein at least one of steps (i) and (ii) is performed:
(i) recording at least one measurable variable, inherent to the caterpillar track, of modules of the caterpillar track that resist or apply drawing force;
(ii) recording, and using for activation of a manipulated variable, inherent to the caterpillar track, of modules of the caterpillar track that resist or apply drawing force, at least one measurable variable inherent to the caterpillar track.

2. The caterpillar track drawing method according to claim 1, wherein the at least one measurable variable is a drawing chain measurable variable of at least one of the first and second drawing chains selected from the following group of drawing chain measurable variables:
drawing chain speed
drawing chain clamping pressure
drawing chain vibration
drawing chain temperature
drawing chain offset.

3. The caterpillar track drawing method according to claim 1, wherein the at least one measurable variable is a drive train measurable variable of at least one of the first and second drawing chains selected from the following group of drive train measurable variables:
chain wheel torque
chain wheel rpm
chain wheel vibration
chain wheel temperature.

4. The caterpillar track drawing method according to claim 1, wherein the at least one measurable variable is a frame measurable variable selected from the following group of frame measurable variables:
frame vibration
oscillation
pressing pressure.

5. The caterpillar track drawing method according to claim 1, further comprising recording a material speed as an additional measurable variable and using the material speed for activation of a manipulated variable inherent to the caterpillar track in step (i) or as the manipulated variable inherent to the caterpillar track in step (ii).

6. The caterpillar track drawing method according to claim 1, wherein in step (ii) the manipulated variable is a drawing chain measurable variable of at least one of the first and second drawing chains selected from the following group of drawing chain measurable variables:
drawing chain speed
drawing chain clamping pressure.

7. The caterpillar track drawing method according to claim 1, wherein in step (ii) the manipulated variable is a drive train measurable variable of at least one of the first and second drawing chains selected from the following group of drive train measurable variables:
gear mechanism settings
chain wheel torque
chain wheel rpm.

8. The caterpillar track drawing method according to claim 1, wherein in step (ii) the manipulated variable is a frame manipulated variable comprising a pressing pressure.

9. The caterpillar track drawing method according to claim 1, further comprising determining from the at least one measurable variables inherent to the caterpillar track at least one of the following:
a chain offset of the first and second drawing chains relative to one another
a wear of the first and second drawing chains
a slipping between the workpiece and at least one of the first and second drawing chains.

10. The caterpillar track drawing method according to claim 1, wherein in step (ii) at least one regulating variable inherent to the caterpillar track is regulated by manipulating the manipulated variable.

11. The caterpillar track drawing method according to claim 10, further comprising regulating at least one of the following:
the chain offset of both the first drawing chain and the second drawing chain relative to one another
a slipping between at least one of the first and second drawing chains and the workpiece
the chain tension of at least one of the first and second drawing chains.

12. A caterpillar track drawing machine comprising:
a drawing die; and
a caterpillar track disposed behind the drawing die as seen in a drawing direction and configured to draw a workpiece along a drawing line aligned parallel to the drawing direction while forming the workpiece by the drawing die;
wherein the caterpillar track comprises circulating first and second drawing chains comprising chain links circulating parallel to a drawing plane;
wherein each of the first and second drawing chains is guided around first and second chain wheels having first and second axes aligned perpendicular to the drawing plane;
wherein the caterpillar track drawing machine further comprises at least one of features (i) and (ii):
(i) measurable variable recording means for recording at least one measurable variable, inherent to the caterpillar track, of modules of the caterpillar track (11) that resist or apply drawing force;
(ii) measurable variable recording means for recording at least one measurable variable inherent to the caterpillar track and at least one actuator, inherent to the caterpillar track, of modules of the caterpillar track that resist or apply drawing force, and a control unit, wherein the control unit has a recording means input and an actuator output, wherein the recording means input is connected with the measurable variable recording means in a relationship that transmits measurable variables and the actuator output is connected with the actuator, inherent to the caterpillar track, in an activating relationship.

13. The caterpillar track drawing machine according to claim 12, wherein the measurable variable recording means comprise drawing chain measurable variable recording means selected from the following group of drawing chain measurable variable recording means:
drawing chain speed recording means
drawing chain clamping pressure recording means
drawing chain vibration recording means
drawing chain temperature recording means
drawing chain offset recording means.

14. The caterpillar track drawing machine according to claim 12, wherein the measurable variable recording means comprise drive train measurable variable recording means selected from the following group of drive train measurable variable recording means:
chain wheel torque recording means
chain wheel rpm recording means
chain wheel vibration recording means
chain wheel temperature recording means.

15. The caterpillar track drawing machine according to claim 12, wherein the measurable variable recording means comprise frame measurable variable recording means selected from the following group of frame measurable variable recording means:
frame vibration recording means
oscillation recording means
pressing pressure recording means.

16. The caterpillar track drawing machine according to claim 12, further comprising material speed recording means.

17. The caterpillar track drawing machine according to claim 12, wherein in feature (ii) the actuator is a drawing chain manipulated variable actuator selected from the following group of drawing chain manipulated variable actuators:
drawing chain speed actuator
drawing chain clamping pressure actuator.

18. The caterpillar track drawing machine according to claim 12, wherein in feature (ii) the actuator is a drive train manipulated variable actuator selected from the following group of drive train manipulated variable actuators:
gear mechanism setting actuator
chain wheel torque actuator
chain wheel rpm actuator.

19. The caterpillar track drawing machine according to claim 12, wherein in feature (ii) the actuator is a frame manipulated variable actuator comprising a pressing pressure actuator.

20. The caterpillar track drawing machine according to claim 12, further comprising at least one of the following determining means configured to use the at least one measurable variable inherent to the caterpillar track:
chain offset determining means
wear determining means
slipping determining means.

21. The caterpillar track drawing machine according to claim 12, wherein in feature (ii) the control unit comprises at least one of the following:
a chain offset control unit
a slipping control unit
a chain tension control unit.

22. A regulating method for regulating the caterpillar track drawing machine according to claim 12, wherein the caterpillar track drawing machine comprises feature (ii) and the control unit comprises at least one of the following:
a neural network
fuzzy logic
artificial intelligence
a control program for a programmable computing machine.

23. A regulating method for regulating the caterpillar track drawing machine according to claim 12, wherein the caterpillar track drawing machine comprises feature (ii) and wherein at least one of a drawing chain offset between the drawing chains and a slipping between the workpiece and at least one drawing chain are regulated by manipulation of the at least one actuator as a function of the at least one measurable variable, inherent to the caterpillar track, recorded by the measurable variable recording means.
